(19) United States
(12) Patent Application Publication
(10) Pub. No.: US 2010/0167220 A1
(43) Pub. Date: Jul. 1, 2010

(54) Sound Reduction Provision for Heat Apparatuses

(75) Inventors: Frank Peter Geelen, Venlo (NL); Johan Servaas Maria Geraads, Steyl (NL)

Correspondence Address: HOFFMANN & BARON, LLP, 6900 JERICHO TURNPIKE, SYOSSET, NY, 11791, US

(73) Assignee: ALUHEAT B.V., Belfeld (NL)

(21) Appl. No.: 12/293,595

(22) PCT Filed: Mar. 20, 2007
(86) PCT No.: PCT/NL07/50115

§ 371 Date: Apr. 7, 2009

(30) Foreign Application Priority Data
Mar. 22, 2006 (NL) 1031424

(51) Int. Cl. F23M 9/00; F23M 99/00; F24H 1/10; F16L 55/02

(52) U.S. Cl. 431/114; 122/18.1

(57) ABSTRACT

A heat apparatus (1), in particular for providing heating in a space, such as central heating, or for heating tap water in, for instance a boiler, comprising: a burner; provided with a guide channel for air supply and/or flue gas discharge; wherein in the guide channel a sound reflecting structure (10) is included extending transversely relative to the guide channel, and designed for damping a sound caused by the burner by means of sound reflection.

The invention relates to a heat apparatus, in particular for providing heating in a space, such as central heating, and/or for heating tap water in, for instance, a boiler.

In a heat apparatus, these functions may also be combined, known as combination boiler. With existing heat apparatuses, a heat exchanger is utilized which transfers the heat of the burner to the water to be heated. Such a heat exchanger comprises a burner chamber and, contiguous thereto, a heat exchanging area. From the heat exchanging area, further, a flue gas outlet channel extends. To the burner chamber, an air inlet is connected. In the following, the channels that are functional to the burner, in particular the air inlet and flue gas outlet will, generally, be indicated as guide channel.

The current type of central heating boilers, in particular of the premix type, can have considerable problems with regard to undesired sound production in the guide channels. These problems are difficult to anticipate upon development, because a heat exchanging apparatus must be able to operate with different gas qualities, such as they are supplied in different countries. For that reason, it is difficult to anticipate the nature and intensity of the developed burner sound, which often necessitates empirical adjustment of the burner.

The object of the invention is to provide a heat apparatus with which the above-mentioned sound production is less problematic. In another aspect, the object of the invention is to provide an apparatus with which, in an efficient and inexpensive manner, sound reduction is utilized, inter alia with existing burner types.

In a further aspect, the invention relates to an apparatus according to the features of claim 1.

According to the invention, the heat apparatus is, in particular, provided with a sound reflecting structure, extending in the guide channel transversely to the guide channel, and designed for damping a burner sound by means of sound reflection. Due to such a structure, annoying sound production can be prevented from occurring while the through-flow of supply air and flue gas is relatively unhindered.

The invention will be further elucidated with reference to the drawing. In the drawing:

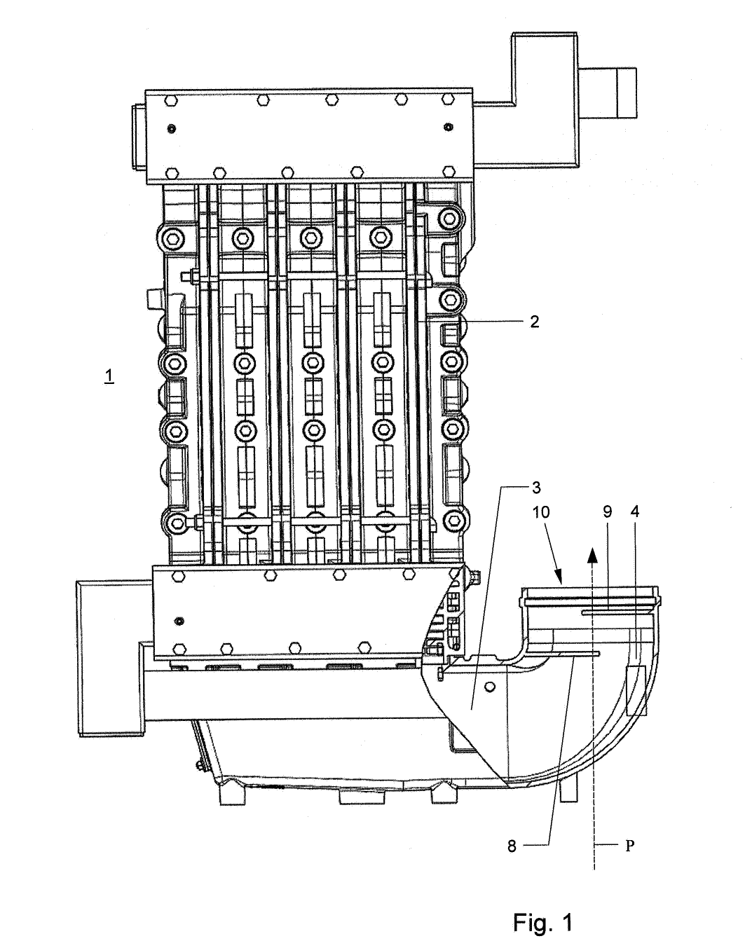

FIG. 1 shows a general, schematic representation in cross-section of a heat apparatus according to the invention;

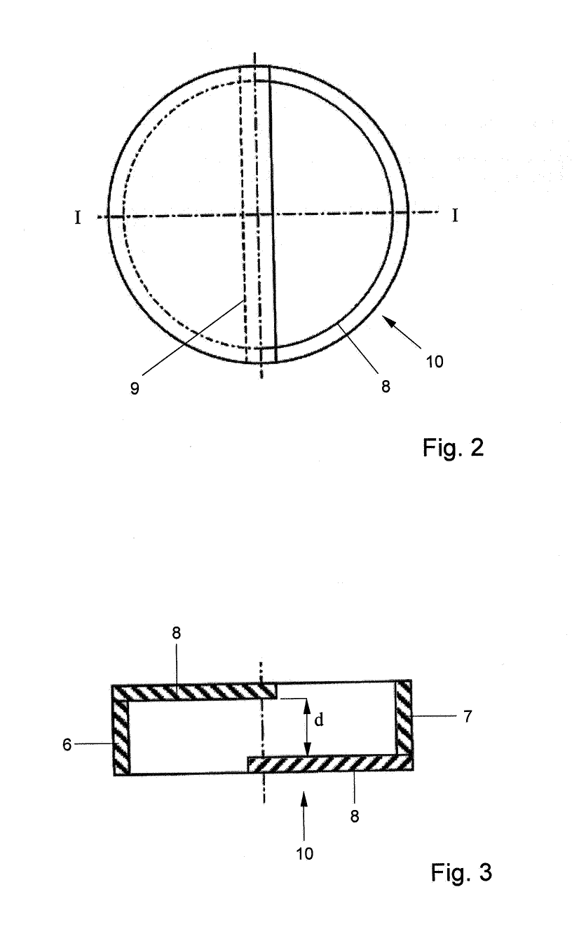

FIG. 2 shows a cross-section of the flue gas outlet channel viewed in the direction of arrow P in FIG. 1; and

FIG. 3 shows a cross-section of the structure of FIG. 2, viewed along the line I-I.

In this description, identical or corresponding parts have identical or corresponding reference numerals. The embodiments shown serve merely as illustration and should not to be construed to be limitative in any manner.

Presently, with reference to FIG. 1, an embodiment of the invention will be discussed in which a sound reducing structure is used in a central heating apparatus 1. Such an apparatus 1 has a heat exchanger 2 in which or on which a burner (not shown) is received. Flue gases from the burner flow through the heat exchanger 2 and, optionally after having passed a condensate tray 3, end up in a flue gas outlet 4. For that reason, flue gas outlet 4 forms a guide channel for discharging flue gases. As is represented in the Figure, a set of reflecting plates 8, 9 is included in the flue gas outlet 4. The reflecting plates 8, 9 form a sound reflecting structure 10, in particular a sound reflecting structure 10 that comprises a plate structure extending over a cross-section of the flue gas outlet 4. Due to geometry and burner type, in the central heating apparatus 1, particular frequencies are inherently strongly present in the sound the apparatus produces. The frequency thereof can be counteracted by the reflecting plates 8, 9 and, hence, be damped, in that the sound wave belonging to the frequency is reflected in a manner such that the reflected wave is in antiphase with the sound wave belonging to the original frequency.

FIG. 2 shows, more specifically, a view of the reflecting structure shown in FIG. 1, viewed in the direction of the arrow P; FIG. 3 shows a cross-section thereof along the line I-I. As is represented, the structure 10 is formed by a set of plates 8, 9 attached to opposite walls 6, 7 of the flue gas outlet, which are mutually interspaced and, viewed in the direction P at right angles to the plane of the drawing, partly overlap each other. For a proper damping, the mutual distance d between the plates 8, 9 must not be too large, without, for that matter, hindering the outflow of flue gases too much. In practice, as a rule, a mutual distance of a few tens of millimetres will suffice. The cross-section of the flue gas outlet shown in FIGS. 2 and 3 is round; naturally, other shapes are possible, in particular adjusted to the respective guide channel. A similar structure as shown in FIG. 1 for the flue gas channel can be incorporated in the air inlet.

In the following, it will be set forth how the reflecting structure can be provided, in existing or new installations.

In order to determine at which location the sound wave is to be reflected, the wavelength is determined by measuring the (resonance) frequency. This is done by analyzing the acoustic spectrum of the sound. According to known relations, the wavelength of the sound depends on the temperature and gas composition, so that a wavelength of the resonance frequency can be determined after temperature measurement.

At the location where the (resonance) frequency is measured, therefore, also the temperature is measured. Then, the wavelength (at this measured temperature) can be calculated, taking into account the composition of the medium the sound wave is in.

The maximum pressure point of a sound wave can be determined through measurement in the channel at the location where the resonance frequency is most strongly present, for instance with the aid of a microphone moved along the channel or through the channel. Then (taking into account a possible temperature development) the maximum velocity and pressure points of the sound wave belonging to the (resonance) frequency can be determined. Preferably, the sound wave is reflected so as to enter into antiphase and thus counteract the resonance. Alternatively, the reflection can be provided in the channel a whole number of quarter wavelengths or half wavelengths higher or lower. Several reflection structures can be arranged at mutual distances from each other for damping other resonance frequencies.

In one embodiment, the analysis can be carried out at a predetermined temperature which is not the operational temperature of the heat apparatus. This may for instance be required with installations that, in operation, run on different gas compositions. In this case, at the predetermined temperature, a microphone can be moved in order to detect one or several positions with a maximum sound intensity. Then, by taking into account the temperature development and the gas composition, the positions can be calculated of the local, maximum sound intensity at an operational temperature. Then, at at least one of these calculated locations, a sound reflecting structure according to the invention can be disposed.

The structure 10 can be fixedly included in the, a or each guide channel, by attaching the plates 8, 9 to the wall 6, 7 of the channel itself, but can also be placed as a separate unit, with the walls 6, 7 forming a part thereof. Such a unit can then be provided in a guide channel, for instance during or after setting into operation. Attachment is possible through, for instance, clamping, gluing, welding, screwing etc. Optionally, the unit can be adjustable in a manner such that, for instance, the distance between the plates is adjustable and/or the position in the channel is slideable.

The invention is not limited to the examples represented in the Figures, but can also relate to other embodiments, burner types and the like, without departing from the scope of the claims. In particular, the reflecting structures can be provided in other channels, for instance the air inlet of the burner. Further, instead of plates mounted on opposite walls, also plates with perforations can be used. In one embodiment, a perforation pattern in a plate can extend over the entire cross-section of the channel. At a short distance behind it, a second plate can be arranged with a pattern which is conjugated to the perforation pattern so that, viewed in the longitudinal direction, a reflection structure extends over the entire cross-section of the channel. Several plates 8, 9 and/or structures 10 can be placed behind each other and/or next to each other. The heat exchanger 2 and/or the burner are preferably cast, in particular from light metal such as aluminum or an alloy. The heating apparatus can have various forms as known from the state of the art, and can be designed to be condensing or not condensing. Such embodiments are understood to fall within the scope of the claims as defined in the following.

1. A heat apparatus, in particular for providing heating in a space, such as central heating and/or for heating tap water, in, for instance, a boiler or tapping coil, comprising:
a heat exchanger and a burner; provided with at least one guide channel for air supply and/or flue gas discharge;
characterized in that
in the at least one guide channel, a sound reflecting structure is included, extending at least partly transversely to the guide channel, and designed for damping a sound caused by the burner by means of sound reflection.

2. A heat apparatus according to claim 1, characterized in that the sound reflecting structure comprises a plate structure extending over a cross-section of the guide channel.

3. A heat apparatus according to claim 2, characterized in that the plate structure comprises at least one pair of plates attached on opposite walls of the guide channel, which are spaced apart and, viewed in the longitudinal direction of the channel, partly overlap.

4. A heat apparatus according to claim 3, wherein the plates are closed and each extend at least over half of the guide channel, viewed in flow direction.

5. A sound reflecting structure for a heating apparatus, comprising at least two plate parts extending approximately parallel, spaced apart, in a first direction, which, viewed in a direction at right angles to the first direction, partly overlap.

6. A method for providing a heat installation with a sound damping apparatus, comprising: determining, in a guide channel of the heat installation, one or more positions with a local maximum sound intensity in an operative condition; and providing a sound reflecting structure on the determined one or several positions.

7. A method according to claim 6, further comprising moving a microphone at a predetermined temperature and air flow velocity along an inlet and/or outlet channel in order to detect the one or several positions with a maximum sound intensity; and calculating the positions of the sound intensity at an operational temperature.
